(19) United States
(12) Patent Application Publication
(10) Pub. No.: US 2025/0371479 A1
(43) Pub. Date: Dec. 4, 2025

(54) INFORMATION MODELING FOR INFRASTRUCTURE LIFECYCLE MANAGEMENT IN AN INFORMATION PROCESSING SYSTEM

(71) Applicant: Dell Products L.P., Round Rock, TX (US)

(72) Inventor: Shiva Prasad, Bangalore (IN)

(21) Appl. No.: 18/680,455

(22) Filed: May 31, 2024

(51) Int. Cl. G06Q 10/067

(52) U.S. Cl. CPC G06Q 10/067

(57) ABSTRACT

Techniques for lifecycle management with information modeling functionalities in information processing systems are disclosed. For example, a method models a set of specifications across multiple phases of a management lifecycle associated with an infrastructure solution, based on a set of user inputs, by generating a set of information assets from at least a portion of the set of specifications, wherein one or more of the information assets define relationships between two or more of the specifications. The method utilizes at least a portion of the set of information assets to enable a set of services configured to manage the infrastructure solution.

### FIELD

The field relates generally to information processing systems, and more particularly to techniques for infrastructure lifecycle management in such information processing systems.

### BACKGROUND

Enterprises such as, e.g., original equipment manufacturers (OEMs) of electronic equipment, typically offer infrastructure solutions (e.g., hardware, software, operating systems, etc.) to customers based on customer needs. Such infrastructure solutions offered by OEMs to customers go through lifecycle phases including, e.g., planning, procurement, deployment, maintenance, and decommissioning. Each phase has various information assets to be maintained and processed by the OEM. However, lack of proper management of such information assets can have significant technical drawbacks.

Such technical drawbacks can have adverse technical effects with respect to resources of the underlying distributed computer network on which phases of the infrastructure solution lifecycle are managed. For example, computer processing delays, data storage shortages, and/or communication network congestion occurs, especially when the lack of proper information asset management causes additional resources (e.g., compute, storage, and network resources) to be needed.

### SUMMARY

Illustrative embodiments provide techniques for lifecycle management with information modeling functionalities in information processing systems.

For example, in one or more illustrative embodiments, a method models a set of specifications across multiple phases of a management lifecycle associated with an infrastructure solution, based on a set of user inputs, by generating a set of information assets from at least a portion of the set of specifications, wherein one or more of the information assets define relationships between two or more of the specifications. The method then utilizes at least a portion of the set of information assets to enable a set of services configured to manage the infrastructure solution.

Advantageously, illustrative embodiments provide methods and system architectures to achieve solution information modeling and extend the modeled information to provide various systems management services.

These and other illustrative embodiments include, without limitation, methods, apparatus, networks, systems and processor-readable storage media.

### BRIEF DESCRIPTION OF THE DRAWINGS

FIG. 1 illustrates an information processing system in which lifecycle management functionalities with information modeling according to one or more illustrative embodiments can be implemented.

FIG. 2A illustrates a system architecture for lifecycle management with information modeling according to an illustrative embodiment.

FIGS. 2B and 2C illustrate an example of information modeling in accordance with the system architecture of FIG. 2A.

FIG. 3 illustrates a methodology for lifecycle management with information modeling according to an illustrative embodiment.

FIGS. 4 and 5 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

As mentioned, infrastructure solutions offered to customers go through lifecycle phases such as, e.g., planning, procurement, deployment, maintenance, and decommissioning. Each phase has various information assets to be maintained and processed, such as, by way of example only:

1. Datacenter planning: bill of materials (BOM) containing a list of supported components and their quantities to be defined for a specific solution requirement and a hardware specifications document containing a recommended configuration for solution deployment and expansion.

2. Procurement: purchase orders involving a list of components, prices, quantities and service agreements identified by stock keeping units (SKUs) and solution orchestration.

3. Provisioning via deployment: “day 0” operation of systems management involving: (a) tuning against validated hardware configurations; (b) update of the solution components to latest levels (versions); and (c) installation of an operating system (OS) and applications.

4. Maintenance: “day N” operation of systems management involving: (a) compliance management of recommended configurations, update baselines and security policies, and non-compliance requiring remediation; and (b) backups, monitoring of infrastructure metrics, troubleshooting, and reporting.

5. Decommissioning or repurposing: retiring an infrastructure based on usage, warranty, and refresh information by identifying, recording, teardown, and termination of contract identified via SKUs, warranty, and remote systems management cleanup operations such as backup, license, data removal, and power down.

Information assets required in each lifecycle phase are typically maintained in information silos. For example, a hardware support matrix (including hardware and software information assets) generated in a BOM may not be used while creating baselines and recommendations for solution hardware and update configurations.

It is realized that when information assets available at individual phases of the solution lifecycle are not exchanged or leveraged, this results in technical issues such as inconsistency in solution lifecycle management, inefficiency in infrastructure solution engineering leading to slower time to market (TTM), and lower flexibility for integration and extension of current capabilities.

The above-mentioned technical problems can cascade to multiple other technical problems such as, by way of example only:

1. Complexity in update operations leading to usage of common utilities which reduces the performance (since they are not built to address any specific solution).

2. Significant efforts on solution specific engineering to deliver common services since there is no common model and individual solutions are engineered in silos.

3. No leverage to engineer and offer new services across a multi-vendor cloud or hybrid infrastructure.

4. Update management services are not unified across all components since there is no common bundle for the OS, systems management applications, and hardware patches together.

Considering the lack of information sharing between solution management services as a core root cause to the above and other technical challenges, it is realized herein that modeling the information across multiple (preferably, all) phases of a solution lifecycle improves efficiency in lifecycle operations of the infrastructure solution, and enables new capabilities with integrations and extensions to systems management applications with faster TTM and consistent management across multiple infrastructure platforms.

Accordingly, illustrative embodiments provide methods to achieve solution information modeling and systems to extend the modeled information to provide various systems management services.

More particularly, in one or more illustrative embodiments, a method to achieve the above and other technical advantages defines a system with:

1. A unified database library of data artifacts such as, e.g., platform, component, OS, and software specifications with common updates and a configuration specifications repository.

2. An information modeling management engine which intakes the solution requirement(s) and converts the data from the library into information with relationships. Outcomes of this modeling are a set of information assets that are standardized and more accurate to accommodate systems management services. Information assets include, but are not limited to, configuration baseline specifications, update catalog bundles, security policy baseline specifications, support matrices associated with SKUs, and BOMs from SKUs.

3. An extension services hub containing services that extend the information from the model into capabilities for users via systems management applications and for a solution orchestrator application and solution proposal (new/refresh) analytics applications.

Advantageously, illustrative embodiments provide methods and systems configured to abstract and model information across infrastructure solution lifecycle management (LCM) as an independent/external service. Illustrative embodiments also may comprise a method to transfer the modeled information from one phase of LCM to another. Further, information modeling provided in accordance with illustrative embodiments provides dynamism to a product with respect to design decisions. Still further, illustrative embodiments may comprise a method and a system that provide a ready service of information modeling that can be leveraged (applied or reusable) to offer LCM of a new product. Illustrative embodiments bring engineering efficiency, and avoid manual data errors and consistent user experience. The generated abstract information (data) also enables data sharing between different vendors on a multi-cloud platform.

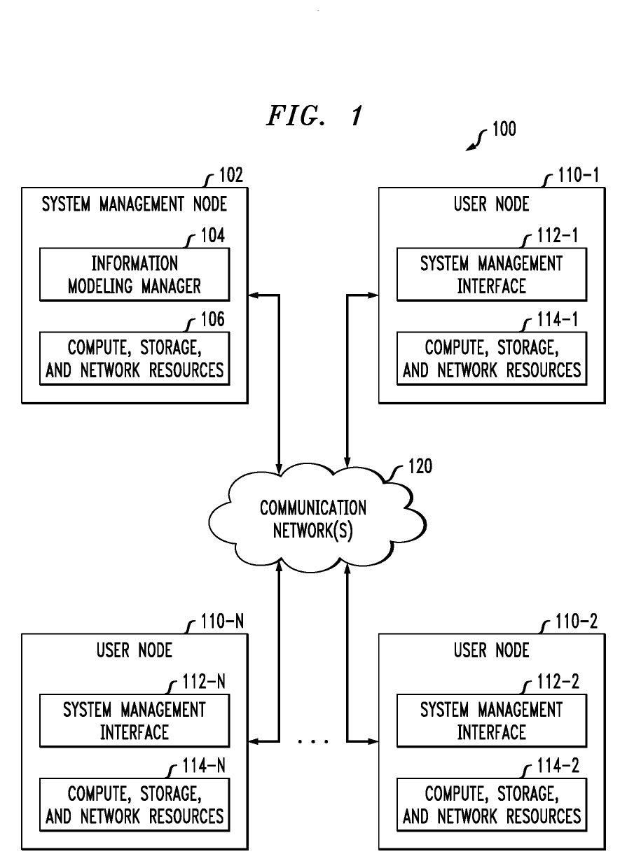

Referring initially to FIG. 1, information processing system 100 depicts lifecycle management functionalities with infrastructure modeling according to one or more illustrative embodiments. As shown, information processing system 100 includes a system management node 102 and user nodes 110-1, 110-2, . . . , 102-N (which may hereinafter each individually be referred to as user node 110 or collectively as user nodes 110). System management node 102 and user nodes 110 are operatively coupled to one another via one or more communication networks 120.

As further shown, system management node 102 comprises an information modeling manager 104 and a set of compute, storage, and network resources 106. User node 110-1 comprises a system management interface 112-1 and a set of compute, storage, and network resources 114-1. User node 110-2 comprises a system management interface 112-2 and a set of compute, storage, and network resources 114-2. Use node 110-N comprises a system management interface 112-N and a set of compute, storage, and network resources 114-N. System management interfaces 112-1, 112-2, . . . , 112-N may hereinafter each individually be referred to as system management interface 112 or collectively as system management interfaces 112. Sets of compute, storage, and network resources 114-1, 114-2, . . . , 114-N may hereinafter each individually be referred to as set of compute, storage, and network resources 114 or collectively as sets of compute, storage, and network resources 114.

In some embodiments, information processing system 100 may be considered an infrastructure solution lifecycle management system. By way of example only, in the above-mentioned OEM scenario, assume system management node 102 manages the lifecycle of an infrastructure solution and user nodes 110 are respectively associated with users or stakeholders in the lifecycle management process. System management node 102 utilizes information modeling management techniques as part of information modeling manager 104, as will be further described herein, to enable sharing and synergies between the various phases of the infrastructure solution lifecycle. System management interfaces 112 in each user node 110 provides application programming interface functions and/or graphical user interface functions to enable user access to the lifecycle management functions.

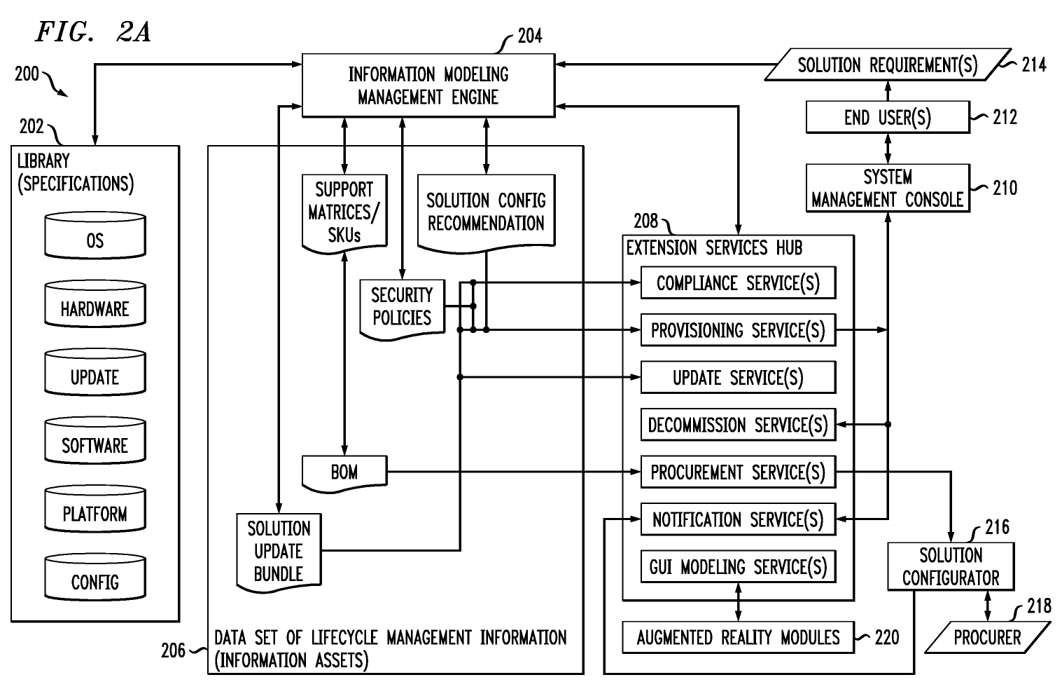

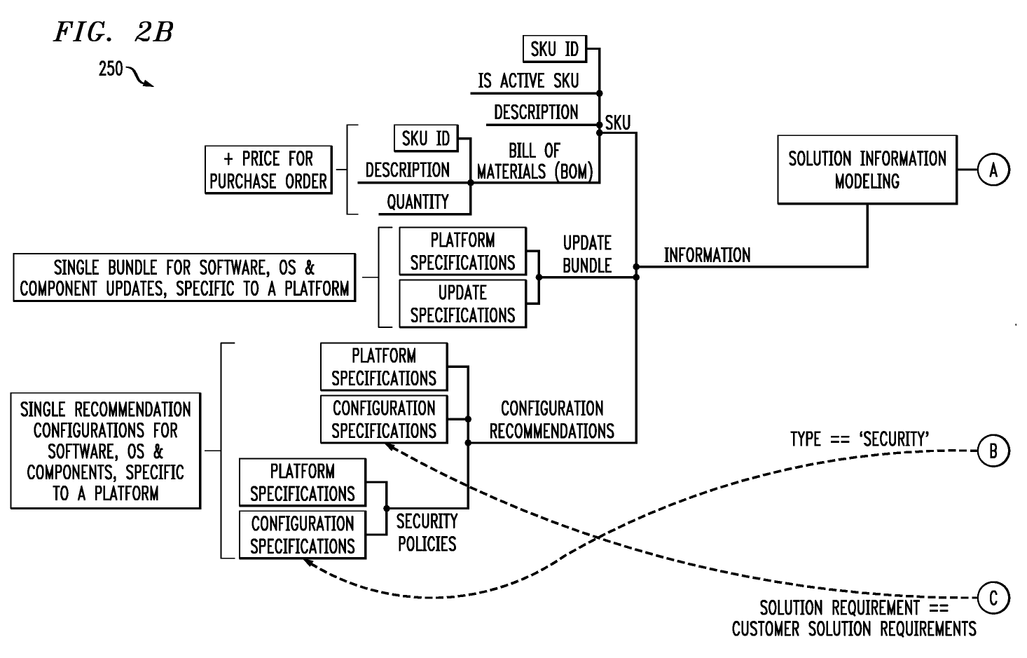

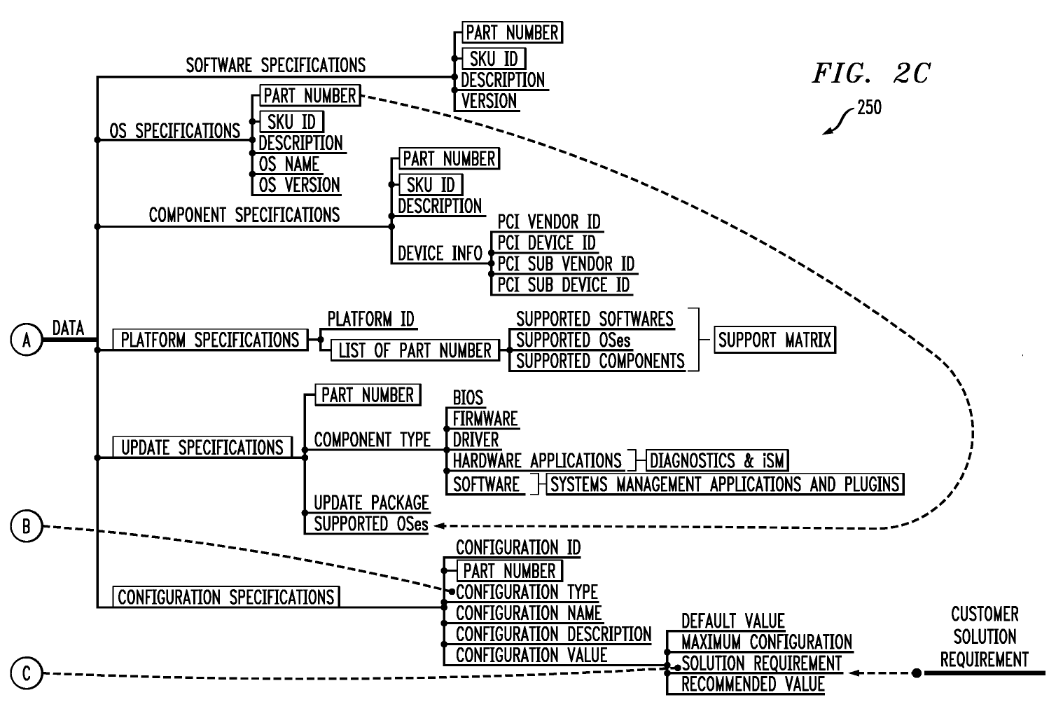

Referring now to FIG. 2A, a system architecture 200 for lifecycle management with information modeling according to an illustrative embodiment is depicted. By way of example only, in some embodiments, system architecture 200 can be implemented by information processing system 100 of FIG. 1. In some other embodiments, management console functionalities can be implemented in one or more of system management interfaces 112 of user nodes 110, while other system architecture components in FIG. 2A that provide lifecycle management with infrastructure modeling can be implemented in system management node 102.

As shown in FIG. 2A, system architecture 200 includes a library 202, an information modeling management engine 204, a data set of lifecycle management information 206, an extension services hub 208, a system management console 210, at least one user (end user) 212, at least one solution requirement(s) 214, a solution configurator 216, a procurer 218, and an augmented reality manager 220. As will be further described, system architecture 200 provides solution information modeling and extends the modeled information to provide various systems management services.

In some embodiments, library 202 functions as a unified database library of data artifacts specifying details about a computing system that can be used to embody one or more infrastructure solutions. More particularly, library 202 can include, but is not limited to, an OS specification, a software specification, a hardware specification , a platform specification, an update specification, and a configuration (config) specification.

By way of further example, library 202 may be designed to comprise software specifications that include: (i) a list of system management applications and extensions; (ii) part numbers and SKU identifiers (IDs) identifying the specification; and (iii) other details such as description, version, licensing, warranty, end-of-life (EOL), and end-of-support-life (EOSL). OS specifications can include: (i) a list of OSs supported; (ii) part numbers and SKU identifiers (IDs) identifying the specification; and (iii) other details such as name, description, version, licensing, warranty, EOL, and EOSL. Hardware specifications can include: (i) a list of hardware components supported; (ii) part numbers and SKU identifiers (IDs) identifying the specification; (iii) other details such as name, description, version, licensing, warranty, EOL, and EOSL; and (iv) device information such as device IDs and vendor IDs. Platform specifications can include: (i) a list of platforms supported; and (ii) a list of software, OS, and hardware specification IDs. Update specifications can include: (i) a list of update packages for each software, OS, and component specification; and (ii) component type, update package path and its support OS. Configuration specifications can include: (i) a list of BIOS and hardware configurations; (ii) configuration type (e.g., security, OS, basic input/output system (BIOS), network, integrated remote access controller (iDRAC), cluster, etc.); and (iii) recommended value(s) for a specific solution requirement (e.g., processor virtualization in BIOS to be enabled for a virtualized workload solution). Still further, by way of further example, library 202 can be extended to include other related information (e.g., known issues, knowledge base links, announcement text, etc.) to enable more services and capabilities that expressly mentioned herein.

In some embodiments, information modeling management engine 204 intakes solution requirement 214 from user 212 and converts data from library 202 into information with relationships. Outcomes of the information modeling performed by information modeling management engine 204 are a set of information assets (a data set of lifecycle management information 206) that are standardized and can more accurately accommodate systems management services. Information assets include, but are not limited to, configuration baseline specifications (solution config recommendation), update catalog bundles (solution update bundle), security policy baseline specifications (security policies), support matrices associated with SKUs, and BOMs from SKUs.

By way of example, in some embodiments of information modeling, portions of the data from library 202 are mapped to other portions of the data to derive relationships and required artifacts for solution capability extension. FIGS. 2B and 2C illustrate an example 250 of information modeling in accordance with the system architecture 200 of FIG. 2A. It is to be understood that example 250 shows relationships and produced outcome in a high-level modeling example. In practice, implementation of information modeling in a distributed computing system may typically include more data and relationship patterns to derive the information assets leveraged for systems management services. In example 250 boxes represent common relationship mapping and arrows indicate connections and filters.

Modeling of the defined data from library 202 as a common model results in multiple information assets as outcome, e.g.:

(i) SKU: a list of SKU IDs mapped to call out whether they are active in the field.

(ii) BOM: a list of components forming a solution, SKU ID of the mapping SKU entry, component description, number of recommended components for the solution. The modeled artifact can also be mapped to a maximum configuration in configuration specification (from library 202) to derive a scaled BOM (or purchase order (PO)). This serves as an artifact to define future scaling needs and approximate cost estimation.

(iii) Update bundle: a single bundle of hardware, OS, and software component updates; mapped to platform and update specification IDs as per support.

(iv) Configuration recommendations: a list of hardware, OS, and solution attributes recommended for a specific solution; mapped to platform and configuration specification IDs as per support and user (e.g., in some cases, customer) solution requirement; further filtering of these recommendations cater to independent requirements such as security policies (e.g., infrastructure lockdown, secure core, etc.) and other independent configuration policies.

In some embodiments, extension services hub 208 contains services that extend the information assets (data set of lifecycle management information 206) resulting from the information modeling performed by information modeling management engine 204 into capabilities for users (user 212) via systems management applications and for a solution orchestrator application (solution configurator 216) and solution proposal (new/refresh) analytics applications. As shown, by way of example only, extension services hub 208 includes at least one compliance service, at least one provisioning service, at least one update service, at least one decommission service, at least one procurement service, at least one notification service, and at least one graphical user interface (GUI) service.

More particularly, extension services hub 208 leverages the modeled information assets (data set of lifecycle management information 206) to provided unified services to customers (e.g., users 212) via systems management applications and to OEM support (e.g., procurer 218 or some other OEM stakeholder) via solution configurator 216.

In some embodiments, extension services hub 208 comprises the following services that can be hosted in a common model mapped to its consuming information assets:

(i) Procurement services: intakes pre-sales proposal of solution infrastructure with BOM details and then converts them into a PO.

(ii) Provisioning services: “Day 0” systems management operation which intakes updates, OS, and recommended configurations to be remediated if non-compliant, and provisions the system for workload deployment.

(iii) Compliance services: “Day 1” systems management operation which intakes policies and updates baselines.

(iv) Update services: “Day N” operation which intakes update, OS, and software to be pushed onto the solution to be up-to-date with security and feature policies.

(v) Notification services: OEM initiated notification which notifies issues, announcements, updates, etc. when an applicable part is available in the customer environment.

(vi) GUI modelling services: leverages augmented reality modules and generated BOM and configuration information to graphically visualize the solution infrastructure.

(vii) Decommission services: retiring or repurposing a solution infrastructure; intakes BOM information to close the agreement and then performs system cleanup.

Several non-limiting use cases will now be given.

Sample use case #1: Cross solution engineering with LCM as a service:

(i) Solution lifecycle management as a service, e.g., update as a service.

(ii) Update service as a common engine with common update catalog schema as a baseline being consumed; common device inventory schema being consumed; workflow to connect iDRAC/OS and perform updates.

(iii) With only catalog entries changing from one solution to another (e.g., from a virtual storage area network (vSAN) ready solution to a hyper converged infrastructure (HCI) solution), update management can be a reusable service with a common information model, and similarly other LCM services.

Sample use case #2: Cross service efficiency with shared support matrix for SKU and configuration recommendation baselines:

(i) Common information assets are designed with recognizable schema.

(ii) Support matrix artifact generated in a common schema is consumed in procurement services to generate BOM from SKU, and in configuration services to generate workload recommendation baselines. Support matrix has mapping of supported platforms in the solution, supported OSs for each platform, a list of hardware components (such as network, storage controllers, drives etc.) and its supported platform/OS mapping. Additionally, in a support matrix, each component maps to its vendor ID, device ID, sub vendor ID, and sub device ID. These IDs map against catalog schema or inventory schema to define an update or configuration baseline.

Advantageously, illustrative embodiments provide a way to abstract and model information across infrastructure solution lifecycle management (LCM) as an independent/external service, as well as providing a method to transfer the modeled information from one phase of LCM to another. Illustrative embodiments provide information modeling that enables dynamism for a product with respect to design decisions. Further, support matrices (e.g., an independent and external service to the product hosted on a cloud platform) provide dynamism on errors and design decisions based on supported OS, platform model, etc. For example, assume a processor model of a platform is refreshed to a newer model. An update to SKU would automatically refresh support matrix, update catalog, and hardware baseline, as well as provide dynamic errors/messages on support for the product without a release churn.

Illustrative embodiments also provide methods and systems that enable a ready service of information modeling that can be leveraged (applied or reusable) to offer LCM of a new product. In one example, SKU gets transferred as a support matrix into Day 0/Day N systems management phase. In another example, SKU and support matrix get transferred to an update catalog bundle. In yet another example, BOM and support matrix get transferred into an OEM recommended hardware configuration baseline (specific to infrastructure/workload). The information modeling according to illustrative embodiments achieves engineering efficiency, avoids manual data errors, and consistent user experience. Generated abstract information (data) can also enable data sharing between different vendors on a multi-cloud platform.

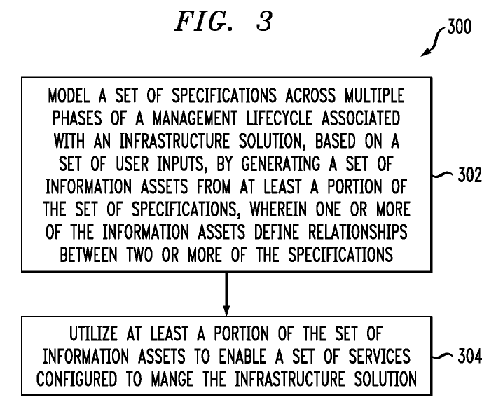

FIG. 3 illustrates a methodology 300 for lifecycle management with information modeling according to an illustrative embodiment. As shown, step 302 models a set of specifications across multiple phases of a management lifecycle associated with an infrastructure solution, based on a set of user inputs, by generating a set of information assets from at least a portion of the set of specifications, wherein one or more of the information assets define relationships between two or more of the specifications. Step 304 utilizes at least a portion of the set of information assets to enable a set of services configured to manage the infrastructure solution.

In some embodiments, the set of specifications comprise information indicative of at least one of one or more operating systems, one or more hardware components, one or more software components, one or more platform components, one or more updates, and one or more configurations associated with a computing system that enables the infrastructure solution.

In some embodiments, the set of information assets comprise information indicative of at least one of one or more security policies, one or more support matrices, one or more configuration recommendations, one or more solution update bundles, and one or more bill of materials associated with the infrastructure solution.

In some embodiments, at least one of the one or more support matrices maps information from two or more of the specifications.

In some embodiments, the set of services comprise at least one of a compliance service, a provisioning service, an update service, a decommission service, a procurement service, a notification service, and a graphical user interface modeling service.

In some embodiments, the method further comprises enabling configuration and deployment of the infrastructure solution.

In some embodiments, the method further comprises dynamically updating one or more of the information assets based on a change to a component in at least one of the specifications.

In some embodiments, at least a portion of the services correspond to the multiple phases of the management lifecycle associated with the infrastructure solution such that one or more of the services utilize common data across the information assets.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

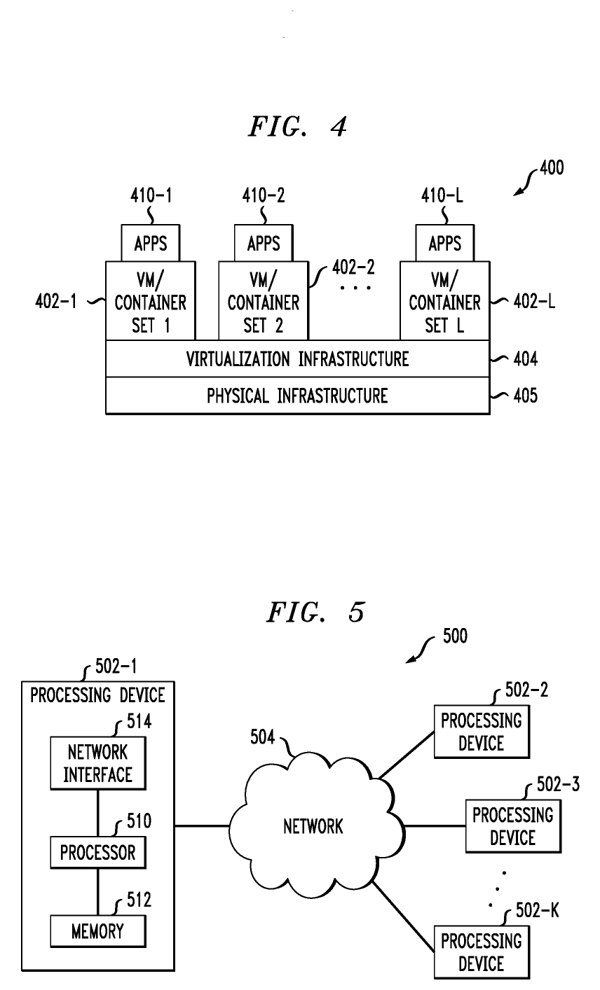

Illustrative embodiments of processing platforms utilized to implement functionality for infrastructure solution lifecycle management with information modeling will now be described in greater detail with reference to FIGS. 4 and 5. Although described in the context of the information processing system environments mentioned herein, these platforms may also be used to implement at least portions of other information processing systems in other embodiments.

FIG. 4 shows an example processing platform comprising infrastructure 400. Infrastructure 400 comprises a combination of physical and virtual processing resources that may be utilized to implement at least a portion of the information processing system 100 in FIG. 1. Infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

Infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 400 shown in FIG. 4 may represent at least a portion of one processing platform. Another example of such a processing platform is processing platform 500 shown in FIG. 5.

The processing platform 500 in this embodiment comprises at least a portion of the information processing systems described herein and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
model a set of specifications across multiple phases of a management lifecycle associated with an infrastructure solution, based on a set of user inputs, by generating a set of information assets from at least a portion of the set of specifications, wherein one or more of the information assets define relationships between two or more of the specifications; and
utilize at least a portion of the set of information assets to enable a set of services configured to manage the infrastructure solution.

2. The apparatus of claim 1 wherein the set of specifications comprise information indicative of at least one of one or more operating systems, one or more hardware components, one or more software components, one or more platform components, one or more updates, and one or more configurations associated with a computing system that enables the infrastructure solution.

3. The apparatus of claim 1 wherein the set of information assets comprise information indicative of at least one of one or more security policies, one or more support matrices, one or more configuration recommendations, one or more solution update bundles, and one or more bill of materials associated with the infrastructure solution.

4. The apparatus of claim 3 wherein at least one of the one or more support matrices maps information from two or more of the specifications.

5. The apparatus of claim 1 wherein the set of services comprise at least one of a compliance service, a provisioning service, an update service, a decommission service, a procurement service, a notification service, and a graphical user interface modeling service.

6. The apparatus of claim 1 wherein the at least one processing platform is further configured to enable configuration and deployment of the infrastructure solution.

7. The apparatus of claim 1 wherein the at least one processing platform is further configured to dynamically update one or more of the information assets based on a change to a component in at least one of the specifications.

8. The apparatus of claim 1 wherein at least a portion of the services correspond to the multiple phases of the management lifecycle associated with the infrastructure solution such that one or more of the services utilize common data across the information assets.

9. A method comprising:
modeling a set of specifications across multiple phases of a management lifecycle associated with an infrastructure solution, based on a set of user inputs, by generating a set of information assets from at least a portion of the set of specifications, wherein one or more of the information assets define relationships between two or more of the specifications; and
utilizing at least a portion of the set of information assets to enable a set of services configured to manage the infrastructure solution;
wherein the modeling and utilizing are performed by at least one processing platform comprising at least one processor coupled to at least one memory configured to execute program code.

10. The method of claim 9 wherein the set of specifications comprise information indicative of at least one of one or more operating systems, one or more hardware components, one or more software components, one or more platform components, one or more updates, and one or more configurations associated with a computing system that enables the infrastructure solution.

11. The method of claim 9 wherein the set of information assets comprise information indicative of at least one of one or more security policies, one or more support matrices, one or more configuration recommendations, one or more solution update bundles, and one or more bill of materials associated with the infrastructure solution.

12. The method of claim 11 wherein at least one of the one or more support matrices maps information from two or more of the specifications.

13. The method of claim 9 wherein the set of services comprise at least one of a compliance service, a provisioning service, an update service, a decommission service, a procurement service, a notification service, and a graphical user interface modeling service.

14. The method of claim 9 further comprising enabling configuration and deployment of the infrastructure solution.

15. The method of claim 9 further comprising dynamically updating one or more of the information assets based on a change to a component in at least one of the specifications.

16. The method of claim 9 wherein at least a portion of the services correspond to the multiple phases of the management lifecycle associated with the infrastructure solution such that one or more of the services utilize common data across the information assets.

17. A computer program product comprising a non-transitory processor-readable storage medium having stored therein program code of one or more software programs, wherein the program code when executed by at least one processing platform causes the at least one processing platform to:
model a set of specifications across multiple phases of a management lifecycle associated with an infrastructure solution, based on a set of user inputs, by generating a set of information assets from at least a portion of the set of specifications, wherein one or more of the information assets define relationships between two or more of the specifications; and
utilize at least a portion of the set of information assets to enable a set of services configured to manage the infrastructure solution.

18. The computer program product of claim 17 wherein the set of specifications comprise information indicative of at least one of one or more operating systems, one or more hardware components, one or more software components, one or more platform components, one or more updates, and one or more configurations associated with a computing system that enables the infrastructure solution.

19. The computer program product of claim 17 wherein the set of information assets comprise information indicative of at least one of one or more security policies, one or more support matrices, one or more configuration recommendations, one or more solution update bundles, and one or more bill of materials associated with the infrastructure solution.

20. The computer program product of claim 17 wherein the set of services comprise at least one of a compliance service, a provisioning service, an update service, a decommission service, a procurement service, a notification service, and a graphical user interface modeling service.
